(19) United States
(12) Patent Application Publication
(10) Pub. No.: US 2010/0083771 A1
(43) Pub. Date: Apr. 8, 2010

(54) Gas sampling apparatus

(76) Inventors: Dennis Coleman, Champaign, IL (US); Todd Coleman, Champaign, IL (US)

Correspondence Address: MICHAEL L. ANTOLINE, 2714 N MATTIS AVE, STE A, CHAMPAIGN, IL, 61822, US

(21) Appl. No.: 12/592,916

(22) Filed: Dec. 4, 2009

Related U.S. Application Data
(62) Division of application No. 10/257,514, filed on Apr. 2, 2003, now Pat. No. 7,647,846.

(51) Int. Cl. G01N 1/22

(52) U.S. Cl. 73/863.71

(57) ABSTRACT

The object of this invention is to provide a gas sampling system capable of taking discreet samples from a continuous flow of gas or fluid. Said apparatus offers a frame (1) and mounting components in the form of a fixed chuck (4) and a spring-loaded chuck with a sample container (5) mounted there between. The sampling container has self-sealing end cap valve assemblies (76) that automatically open when the sample container (5) communicates with the fixed chuck (4) and the spring loaded chuck (6) and the end cap valve assembly automatically closes when the sample container is removed. A value system allows the gas flow to be directed from one sample container to the other alternatively opening and closing a gas flow path. A sample extraction assembly (14) allows the efficient removal of samples from the sample containers. An extension rod pressurizer (117) in conjunction with the end cap value assembly, such as first end cap valve assembly (76) allow the sample to be pressurized to facilitate easy sample removal.

### TECHNICAL FIELD

This apparatus relates to the collection, transportation and analysis of gas samples which may be required in various scientific, environmental and resource contexts. As an example, in oil and natural gas exploration, drilling, recovery and storage, periodic sampling of recovered gases and fluid are required for subsequent analysis. In the oil industry, “mud” is a colloquial term for a thick chemical composition that is pumped into drills as they penetrate the substrate. This “mud” is returned to the surface and contains gases that are released from the rock as the drill penetrates. Significant data is acquired from the analysis of these gases. As a further example, in the context of natural gas storage, large underground storage deposits are often chemically tagged for later identification. This apparatus facilitates the recovery of samples from these storage deposits for testing and identification of the chemical tag.

### BACKGROUND ART

U.S. Pat. No. 5,116,330 to Spencer provided for a sample extraction system with a sampling container and valves. Such a sampling system requires the interruption of the fluid flow as sampling containers are exchanged. Further, extraction of the sample from the sampling container was accomplished by “bleeding” the cylinder, a technique which relies on gravity and is suitable for fluids in a liquid rather than a gaseous state. Currently used in the industry are gas sample bags, which have the obvious problems of fragility, occupying a significant volume when being shipped and the inability to contain gas or fluid under any significant pressure.

### DISCLOSURE OF THE INVENTION

The present invention provides a gas sampling apparatus in which continuous or periodic gas samples may be isolated in gas sampling containers. The gas sampling container associated with this apparatus contains self-sealing valves on either end which open when the sample container is positioned in the apparatus and automatically closes when the sampling container is removed from the apparatus. In one configuration, the apparatus has two gas sampling tubes mounted and the gas flow which is to be sampled is directed into and out of one gas sampling container and then, by operating a valve system, the flow to be sampled can then be directed through a second sample container. Upon removal from the apparatus, the first sample container self-seals and may be transported. An empty container can then take its place. When the valve system again is actuated, the gas flow is re-directed from one sample container to the other. In this way, continuous sampling of a gas flow may be achieved. Further, mechanisms are provided that facilitate the pressurization and removal of gas samples from the sample containers.

### BRIEF DESCRIPTION OF THE DRAWINGS

FIG. 1 is a front elevation view of the major components of the apparatus.

FIG. 2 is a cross sectional diagram of the flow of gas or fluid through the left half of the system.

FIG. 3 is a cross sectional view of the gas flow through the right half of the system.

FIG. 4 is a cross sectional view of the sample extraction assembly.

FIG. 5 is a cross sectional view of a self-sealing chuck.

FIG. 6 is a cross sectional view of a fixed chuck.

FIG. 7 is a plan view of the top of the fixed chuck.

FIG. 8 is a cross sectional view of the sampling container.

FIG. 9 is a perspective view of the sample container ends.

FIG. 10 is a cross sectional view of the spring-loaded chuck with the sample container seated therein.

FIG. 11 is a perspective view of the apparatus.

FIG. 12 is a cross sectional view of the plunger-activated valve.

FIG. 13 is a cross sectional view of an alternative embodiment of a sample container.

FIG. 14 is a cross sectional view of an extension rod pressurizer.

FIG. 15 is a cross sectional view of the first end cap valve body.

FIG. 16 is a view of an alternative mechanism assuaging the ends of the sampling container.

### BEST MODE FOR CARRYING OUT THE INVENTION

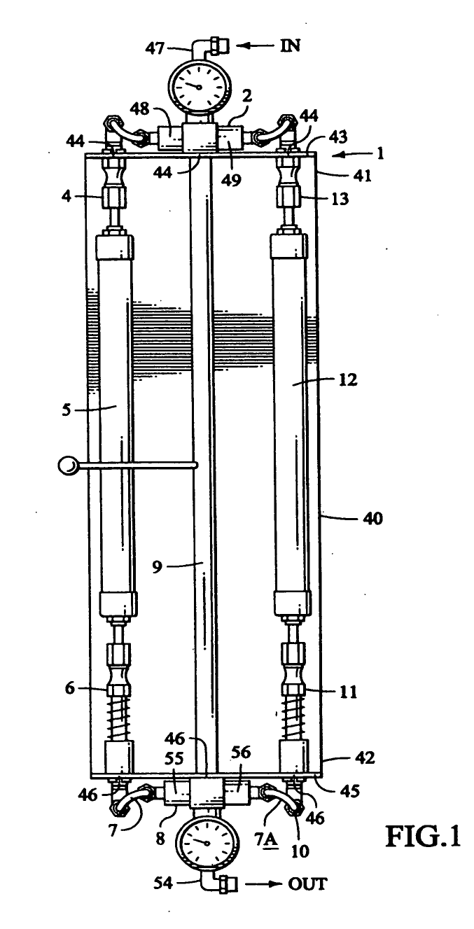

FIG. 1. illustrates the major components of the gas sampling apparatus. The gas sampling apparatus is given structure by its frame 1. The frame is composed of a rigid substance, usually metal, and exhibits a longitudinal planer segment 40. The frame is further composed of a first planer segment end 41 and a second planer segment end 42. A first panel 43 emanates from the first planer segment end 41 and is oriented at right angles to the planer segment 40. The first panel 43 exhibits a plurality of apertures 44. A second panel 45 emanates from the second planer segment end 42 again at right angles to the planer segment 40. The second panel 45 also exhibits a plurality of apertures 46, in this case three in number, that correspond to and are opposite the apertures 44, exhibited by the first panel 43. Mounted to first panel 43 and through the outermost apertures of first panel 43 are fixed chucks 4 and 13. Mounted to second panel 45 and within the outermost apertures 46 are spring-loaded chucks 6 and 11.

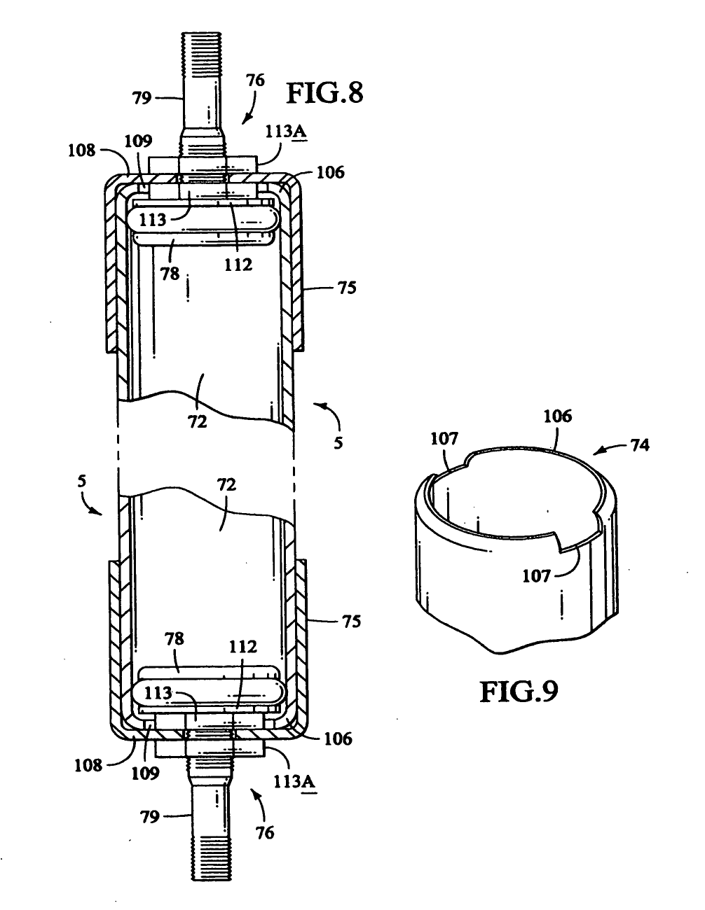

Spring-loaded chuck 6 and spring-loaded chuck 11 as well as fixed chuck 4 and fixed chuck 13 provide the mounting means for first sample container 5 and the substantially similar second sample container 12. Turning for a moment to FIG. 8, it is seen that the first sample container 5 is composed of a annular chamber 72 exhibiting second annular chamber end 73 and first annular chamber end 74. FIG. 9 shows that first chamber end 74 exhibits first swaged edge 106 with two opposite notches 107. Turning to FIG. 16, an alternative means of swaging the edge is seen. Here the edge is swaged in a plurality of small increments or dimples (121) around the edge diameter. This can facilitate the insertion of other forms of end cap valves. Turning now to FIG. 8, the swaged edge 106 of first sample container 5 is shown disposed within the central bore first end cap 75. Disposed through both first annular chamber end 74 and first end cap central aperture 109 is first end cap valve assembly 76.

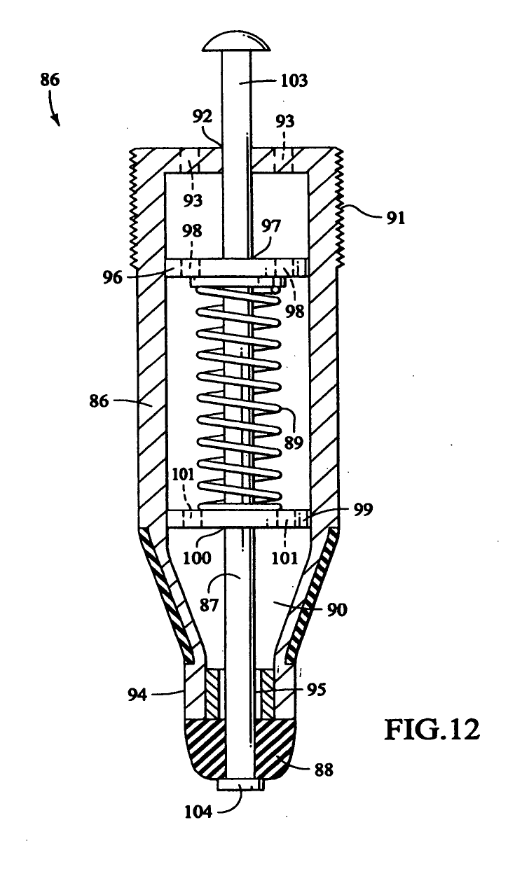

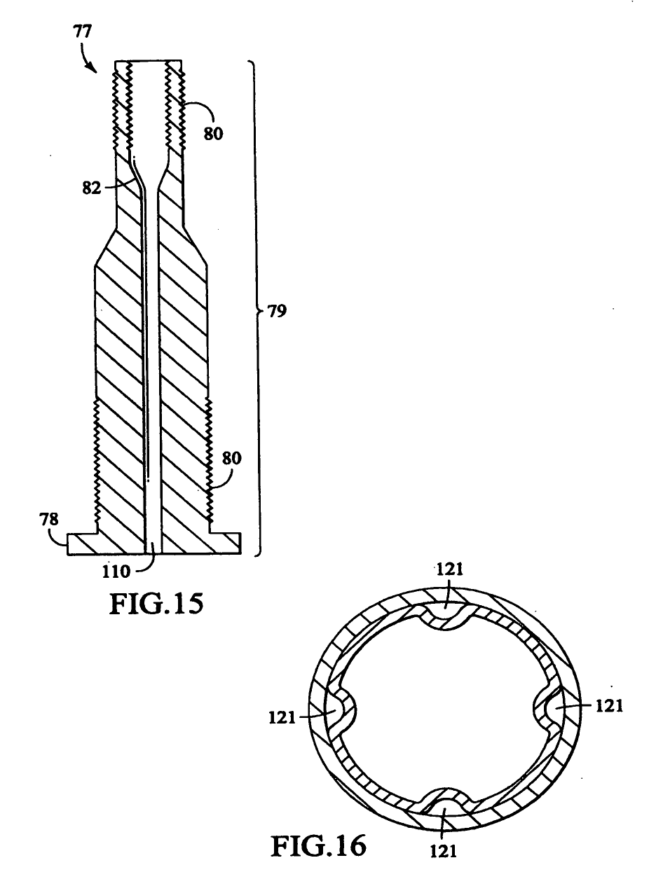

Turning now to FIG. 15, one of the components of the first end cap valve assembly 76, the first end cap valve body 77 is illustrated. It is composed of a transverse base 78 and annular section 79. Annular section 79 exhibits first annular section end 80 and second externally threaded annular section end 81, which is attached to the transverse base 78. Central bore 110 extends through both transverse base 78 and the annular section 79. The first annular section end 80 exhibits both external threads and internal threads within the central bore 110. The central bore 110 exhibits a conical narrowing, the central bore valve seat section 82. It is here that a plunger-activated valve 85 is seated. Turning now to FIG. 12 plunger activated valve 85 is shown. Plunger activated valve 85 is composed of a valve body 86 having a central cavity 90. Externally threaded first plunger valve body end 91 has a central bore 92 and a plurality of apertures 93 that communicate with the central cavity 90. The second plunger valve body end 94 also exhibits a corresponding central bore 95 with an annular space also communicating with the central cavity 90. The exterior of the valve body 86 exhibits a conical plunger valve body segment 105. A plunger valve body gasket 114 is seated around the conical plunger valve body segment 105 and substantially corresponds to the shape of the central bore valve seat section 82 shown in FIG. 15. Within the central cavity 90 are a first plunger rod support 96 having a central bore 97 and a plurality of apertures 98. The first plunger rod support is fixed to the interior walls of the central cavity 90. A second plunger rod support 99 also has a central bore 100 and a plurality of apertures 101. The second plunger rod support 99 is also fixed to the interior walls of the central cavity 90. Thus the central bores of the second plunger valve body end 94, the second plunger rod support 99, the first plunger rod support 96 and the first plunger valve body end 91 all correspond such that plunger 87 can be disposed through all. Plunger 87 has a first plunger end 103 disposed outside central cavity 90 and above valve body 86. A second plunger end 104 is also disposed outside the central cavity 90 and below valve body 86. Plunger 87 also exhibits spring stop 115 fixed to plunger 87 between first plunger rod support 96 and second plunger rod support 99 but at a point on plunger 87 where the spring stop 115 communicates with the interior surface of the first plunger rod support 96 when in a resting position. The resting position is maintained by spring 89 disposed over the plunger rod and communicating with spring stop 115 and the second plunger rod support 99. Fixed to the second plunger end 94 in such a Trimmer as to preclude leakage around the plunger 87 is plunger gasket 88. Plunger gasket 88 seals the central bore 95 and annular space 102 of second plunger valve body end 94 by being held against the second plunger valve body end 94 by the pressure exerted by spring 89 on spring stop 115.

Now returning to FIG. 15, it can be seen that when second plunger valve body end 94 of plunger activated valve 85 is inserted into first annular section end 80 of first end cap valve body 77, externally threaded first plunger valve body end 91 may be disposed within the internal threads of first annular section end 80. Disposition of plunger activated valve 85 is to such a depth as to press plunger valve body gasket 114 firmly against central bore valve seat section 82 creating a seal.

Turning again to FIG. 8, it is seen that an annular rubber ring 111 is disposed over the annular section 79 and seats on the transverse base 78. Washer 112 is likewise disposed over the annular section 79 and seats on the annular rubber ring 111. Nut 113 is then threaded down over the second externally threaded annular section end 81. Insertion of the components of the first end cap valve stem assembly is facilitated by notches 107. Once the first end cap valve assembly 76 is within the first annular chamber 72, nut 113 is tightened thereby applying pressure to washer 112 which in turn applies pressure to and expands the annular rubber ring 111 such that full diameter contact with the walls of the first annular chamber 72 and a tight seal is achieved. The first end cap 75 is then disposed over the first annular chamber end 74. Nut 113A is then disposed over annular section 79 and then threaded over second annular section end 81 until the nut communicates with the end cap exterior 108. The first end cap valve assembly 76 is then drawn toward the first swaged edge 106 which now retains the end cap valve assembly within first annular chamber 72 and holds the end cap in place. The second end cap 83 and second end cap valve assembly are similarly mounted within the second annular chamber end 73.

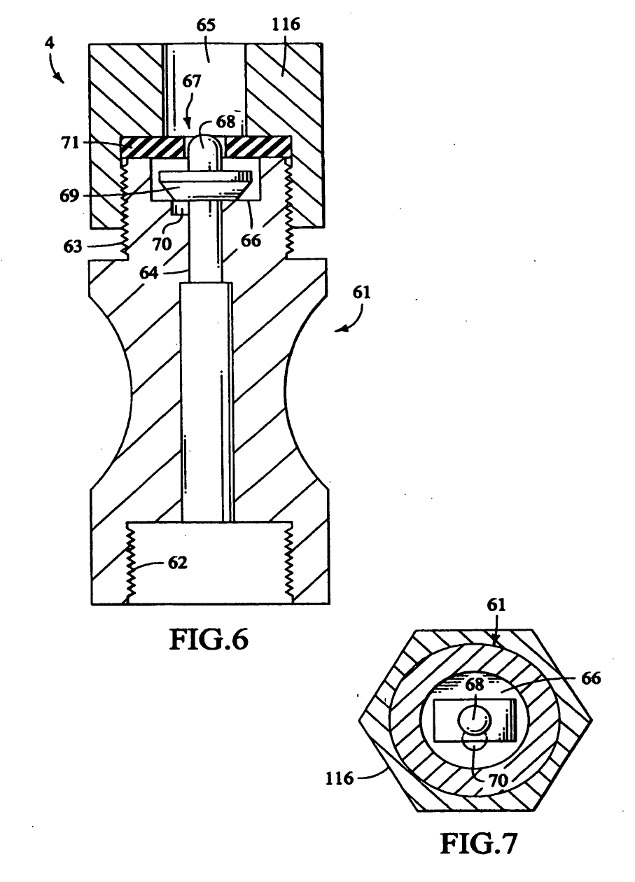

Now turning to FIG. 6, first fixed chuck 4 is illustrated. First fixed chuck 4 is composed of an annular body 61 with externally threaded end 63 and internally threaded end 62. A central bore exists between them. A first central bore section 64 is seen followed by larger diameter second central bore section 65. The differences in diameters produce seat 66. Upon seat 66 rests plunger depressor 67. Plunger depressor 67 has two components, a first finger member 68 and a first transverse member 69. The first transverse member is that portion of the plunger depressor 67, which communicates with the seat 66. A first flexible washer 71 is disposed over the first finger member 68 such that it rests on externally threaded end 63. However, as show in FIG. 7, the first transverse member is not a disk but is rectangular in shape such that only a portion of first flexible washer 71 is in contact with first transverse member 69 thus allowing fluid or gas to flow through first flexible washer 71, past first transverse member 69 into air passage aperture 70 and then into first central bore section 64 and beyond. A first plunger depressor retaining cap 116 is disposed over the externally threaded end 63. It holds washer 71 in position and thereby retains plunger depressor 67. The second fixed chuck is configured substantially similar to the first fixed chuck.

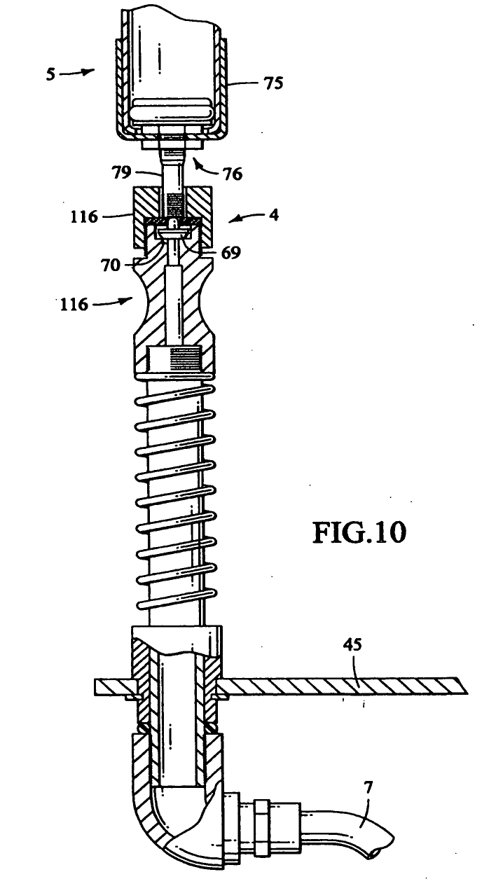

Configured similarly to the fixed chuck is the chuck head 117 of the first and second spring loaded chucks as showed in FIG. 10. Disposed within the internally threaded end of chuck head 117 is pipe 118. Pipe 118 then extends through bushing 121 and is attached to a flexible connector 7 of such a diameter as to prevent pipe 118 from being returned through bushing 121. Bushing 121 is fixed within an outer aperture of panel 45. Spring 118A is disposed over pipe 118 and rests between chuck head 117 and bushing 121. When chuck head 117 is depressed, pipe 118 slides downward through bushing 121. As chuck head 117 is depressed, the tension in spring 118A is increased allowing chuck head 117 to return upward after pressure is released. The second spring loaded chuck is configured in a substantially similar fashion being mounted in the second outermost aperture of panel 45.

It can be envisioned in FIG. 1 that to insert a sample container, for example, sample container 5, the second end cap valve assembly 84 is disposed within the mouth of spring loaded chuck 6. Downward pressure is then applied whereupon spring loaded chuck 6 is pressed down and through spring loaded chuck bushing 121). Spring loaded chuck 6 is able to be depressed a sufficient distance to allow the upper end of sample container 5 to be positioned under fixed chuck 4. Downward pressure on the sample container is then released allowing the first end cap valve assembly 76 of sample container 5 to seat within fixed chuck 4. A similar procedure is utilized to mount the second sample container 12 between spring loaded chuck 11 and fixed chuck 13.

At this point, it is critical to note the insertion of the end cap valve assemblies into spring loaded chuck 6 and fixed chuck 4 causes the ends of the end cap valve assemblies to be pressed into to be pressed against the flexible washers such as the first flexible washer 71 as illustrated in FIG. 10. This produces a seal. A first finger member such as first finger member 68 of plunger depressor 123 will come in contact with a plunger such as plunger 87 of plunger activated valve 85, (Seen in FIG. 12) causing the sample container, such as sample container 5 to open. This happens on both ends of the sample container allowing gas or fluid to pass through when the sample container if seated in the fixed and spring-loaded chucks.

Returning to FIG. 1, first three-way valve 2 is mounted to panel 43 between first fixed chuck 4 and second fixed chuck 13. First fixed chuck 4 is connected to the first valve left outlet 48. The second fixed chuck 13 is connected to the first valve right outlet 49. Mounted so as to read pressure from the first valve inlet 47 is pressure gauge 150. A similar configuration is seen with the second three-way valve 8, which is similarly attached to second panel 45. The first spring loaded chuck 6 is connected to the second valve left inlet 55. Second spring loaded chuck 11 is further connected to second valve right inlet 56. Mounted to communicate and to read pressure from second valve outlet 54 is second pressure gauge 151. Since first spring loaded chuck pipe 118 may be pressed through first spring loaded chuck bushing 121, the first spring loaded chuck 6 is connected to second valve left inlet 55 by means of flexible tubing 7. Similarly, second spring loaded chuck 11 is connected to second valve right inlet 56 by means of flexible tubing 7A. Valve control handle 9 extends through the central aperture 46 and 44 in first panel 43 and second panel 45 respectively. Control handle 9 communicates simultaneously with first three-way valve 2 and second three-way valve 8.

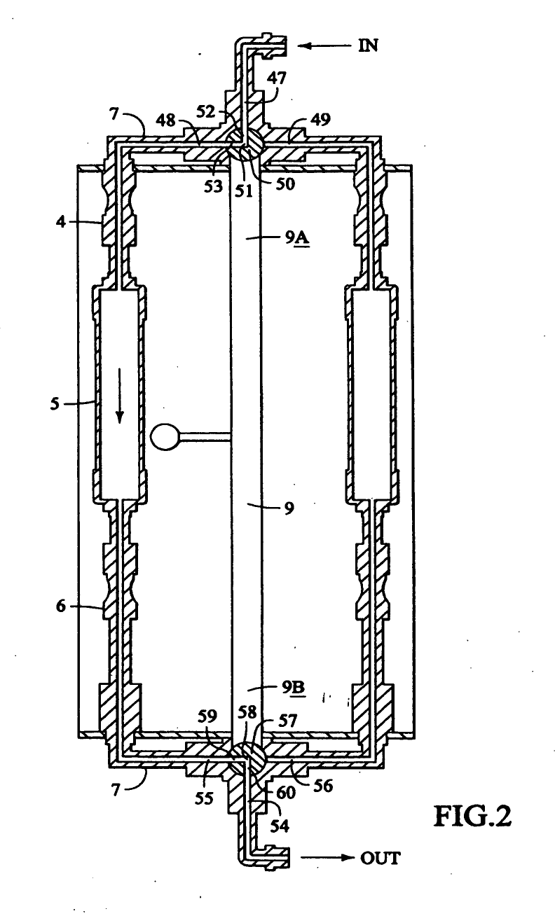

Now turning to FIG. 2, we first see that control handle 9 is oriented toward first sample container 5. Control handle 9 exhibits first control handle end 9A and second control handle end 9B. First control handle end 9A is attached to and operates a first valve flow directing means 50 which is mounted internally in first three-way valve 2. The first valve flow directing means 50 exhibits a passage 51 with a first passage end 52 and a second passage end 53. When the control handle 9 is oriented toward sample container 5, first passage end 52 aligns with first valve inlet 47. Simultaneously, the second passage end 53 aligns with first valve left outlet 48. It can then be seen that gas may flow into the first valve inlet 47 through first valve flow directing means passage 51 out first valve left outlet 48, then through first fixed chuck 4 into sample container 5. Control handle second end 9B is similarly connected to second valve flow directing means 57. The second valve flow directing means exhibits conduit 58 which provides the same function as passage 51 in first valve flow directing means 50. Conduit 58 exhibits a first conduit end 59 and second conduit end 60. Control handle 9 is attached to both the first valve flow directing means 50 and second valve flow directing means 57 such that when the first valve flow directing means 50 is oriented as described above, the second valve flow directing means 57 is oriented in such a way that first conduit end 59 communicates with second valve inlet 55 and second conduit end 60 communicates with second valve outlet 54. It can be seen that any gas or fluid in sample container 5 may then flow through second spring loaded chuck 6 through flexible tubing 7 into second valve left inlet 55 through the second valve flow directing means conduit 58 and finally out second valve outlet 54.

Now turning to FIG. 2A, it can be seen that when handle 9 is directed toward second sample container 12, the first valve flow directing means 50 is oriented such that first passage end 52 communicates with first valve inlet 47 and second passage end 53 is now oriented with first valve right outlet 49. Now it can be seen that gas may flow in first valve inlet 47 through first valve flow directing means passage 51 into the first valve right outlet 49 through fixed chuck 13 and into second sample container 12.

Again, when handle 9 is oriented towards second sample container 12, the second valve flow directing means 57 has its conduit 58 oriented in such a way that first conduit end 59 communicates with second valve inlet 56 and second conduit end 60 communicates with second valve right outlet 54. Now it can be seen that fluid or gas in sample container 12 may flow through spring loaded chuck 11 then through flexible tubing 7A into second valve inlet 56 through passage 58 and into second valve outlet 54.

A method of acquiring samples would be to allow gas to flow through sample container 5 and then after having mounted sample container 12, orienting the control handle so that gas now flows through sample container 12 and gas flow is terminated through sample container 5. In this way, sample container 5 may be removed from the system and an empty sample container mounted. When sufficient sample has been gathered within sample container 12, the control handle 9 would then again be moved toward the fresh sample container thus occluding gas flow through sample container 12 whereupon it may be removed from the system. By alternating the removal of full sample containers and the replacement with empty containers, continuous or periodic samples in a line of gas or fluid flow may be obtained.

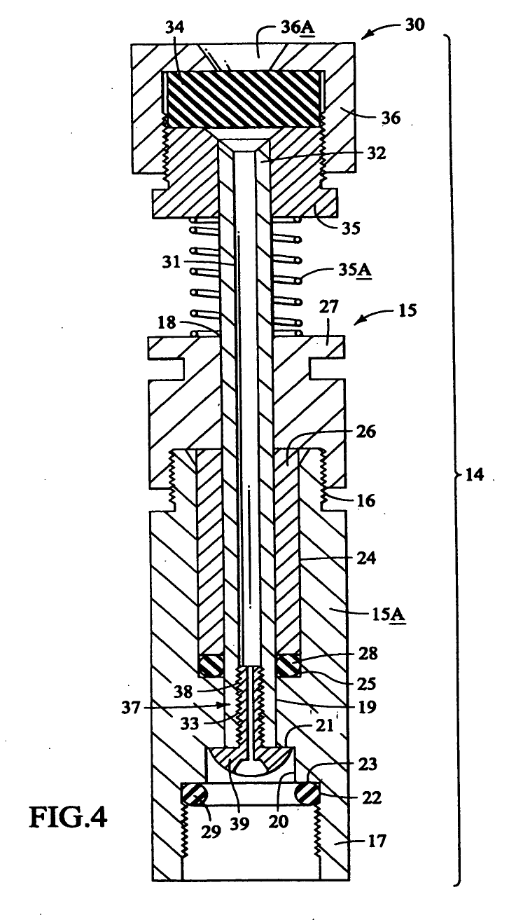

Once the sample container is removed from the gas sampling apparatus the fluid or gas sample must be removed from the container. FIG. 4 illustrates the sample extraction assembly. 14. It is composed of a coupler 15. The coupler 15 exhibits a coupler body 15A. The coupler body has a longitudinal bore allowing for fluid flow. The coupler also has an externally threaded first body end 16 and an internally threaded second body end (17). The central bore is divided into segments of varying diameters. The narrowest diameter is the small diameter segment (19). Below, that is toward the internally threaded second body end (17) is the first larger diameter segment 20. The differences in diameter allow the formation of first lip (21). Again below, toward the internally threaded second body end (17) is the first largest diameter segment (22). The differences in diameter again allow the formation of another lip, second lip (23). Upon second lip (23) rests a second seal (29) usually in the form of a rubber o-ring. This allows the internally threaded second body end to be disposed over the externally threaded end of a first annular section end 80 of an end cap valve assembly such as first end cap valve assembly 76 thus creating a seal for gas or fluid. Returning to the description of the central bore we now have a second larger diameter segment (24) above or toward the externally threaded first body end (16). The difference in diameter between the small diameter segment (19) and a second larger diameter segment (24) creates a third lip (25). Upon this third lip (25) rests first seal (28). Disposed within the second larger diameter segment (24) and resting on the third lip (25) is first seal (28) again seen usually in the form of a rubber o-ring. Annular bushing (26) exhibiting a central bore communicates with the walls of the second larger diameter segment (24) and is coterminous with the externally threaded first body end (16). An internally threaded bushing retaining cap (27) having a central bore, is disposed over the externally threaded first body end (16). The sample release device (30) exhibits stem (31) which is partially disposed within the central bore (18) of busing retaining cap (27), the central bore of the annular busing (26) and the small diameter segment (19) and may slide within. First seal (28) communicates with stem (31) thereby preventing the passage of fluid or gas around the stem. Stem (31) has a first stem end (32) and an internally threaded second stem end (33). Mounted within the internally threaded second stem end (33) is externally threaded stem retaining screw (37) having a threaded portion (38) and a cap portion (39). The cap portion (39) is of a larger diameter than stem (31) and thereby is able to rest on first lip (21). The stem retaining screw (37) thus secures stem (31) within body (15A). The stem retaining screw (37) also exhibits a central bore that communicates with the central bore of stem (31). First stem end (32) is attached to externally threaded septum seat (35). Septum (34) rests on said septum seat (35) and is composed of a penetrable material such as rubber. Septum (34) is held in place by internally threaded septum retaining cap (36). A spring 35A is located between the septum seat (35) and internally threaded bushing retaining cap (27) which is disposed over externally threaded first body end (16).

After the sample extraction assembly (14) is threadedly attached to an end cap valve assembly, such as first end cap valve assembly 76, a needle such as a hypodermic needle, is inserted through the central conical aperture (36A) of the septum retaining cap (36). Depressing the sample release device (30) compresses spring (35A). In turn, stem (31) and stem retaining screw (37) are depressed such that stem retaining screw makes contact with plunger 103 shown in FIG. 12 thereby opening the sample container, such as sample container 5. When this is accomplished the sample may be extracted from the container.

Prior to removing a sample from the sample container, it may be necessary to pressurize the sample. This may be accomplished by removing the cap retaining nut such as retaining nut (113A) and then threadedly mounting extension rod pressurizer 117 to an end cap valve assembly such as first end cap valve assembly (76). By using the extension rod pressurizer 117 to press first end cap valve assembly (76) further into the sample container, increased pressure of the sample may be obtained. Extension rod pressurizer (117) is composed of an internally threaded tube (118) which is disposed over the externally threaded end of the first end cap valve assembly (76). Bolt (119) is threaded into internally threaded tube (118) and held by lock nut (120). The length of the extension rod pressurizer may be adjusted by loosening the lock nut (120) and threading bolt (118) farther into or out of threaded tube (118).

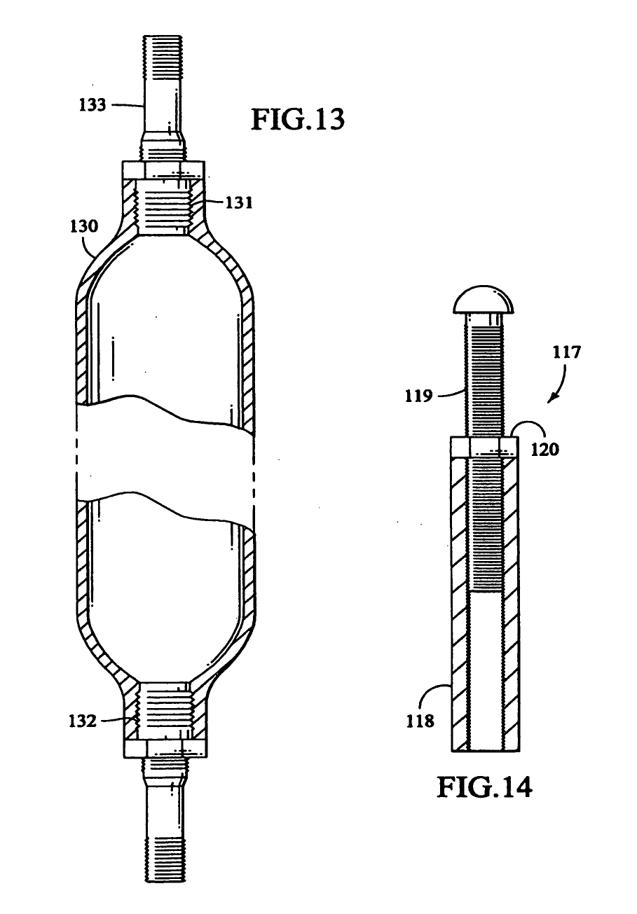

Another form of sample container is illustrated in FIG. 13. Sample container (130) has internally threaded ends (131) and (132). An externally threaded end valve (133) with the same internal mechanism of first end cap valve assembly (76) may then be inserted creating a sample container.

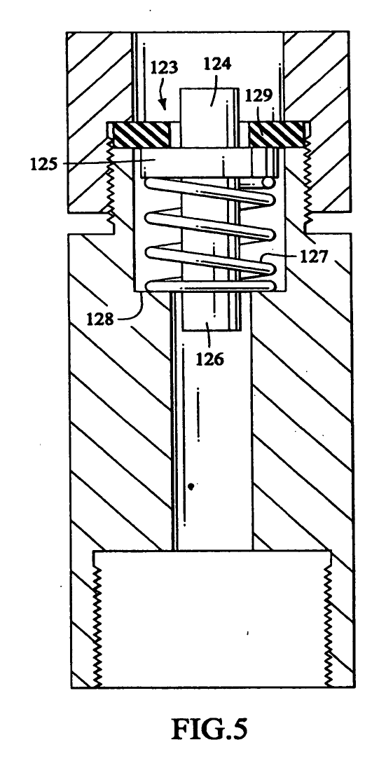

An alternative mode of configuration for the fixed chuck and chuck heads of the spring loaded chuck is seen in FIG. 5. Here, the plunger depressor 123 in addition to a finger member 124 and a transverse member 125, has a stem member 126. Spring 127 rests between seat 128 and transverse member 125. The tension in spring 127 creates a seal between transverse member 125 and seal 129. This configuration allows any fluid or gas trapped in central bore 130 to remain captured. This is especially important when noxious gas for fluid is being sampled with this system.

### INDUSTRIAL APPLICABILITY

As stated earlier, this gas sampling apparatus has applicability to the oil and gas industry. However, it can also find use in any industry in which the continuous sampling of flows of gases or fluids are required. Further, the assembly also has applicability in any industry in which gas samples need to be transported in either a pressurized or unpressurized state and later need to be easily removed for testing.

What is claimed is:

1. A gas sampling apparatus comprising:
a frame,
a first three-way valve attached to said frame,
a first fixed chuck fluidly attached to said first three-way valve,
a first sample container demountably attached to said first fixed chuck,
a first spring loaded chuck demountably attached to said first sample container,
a first flexible connector fluidly attached to said first spring loaded chuck,
a second three-way valve fluidly attached to the first flexible connector,
a valve control handle connected to said first three-way valve and connected to said second three-way valve,
a second flexible connector fluidly connected to said second three-way valve,
a second spring loaded chuck fluidly attached to said second flexible connector,
a second sample container demountably attached to said second spring loaded chuck,
a second fixed chuck demountably attached to said second sample container, said second sample container fluidly attached to said first three-way valve,
a sample extraction assembly capable of being fluidly connected to said first sample container and said second sample container,
an extension rod pressurizer capable of being demountably connected to said first sample container and said second sample container.

2. The gas sampling apparatus of claim 1 wherein said frame further comprises:
a plainer segment having a first plainer segment end and a second plainer segment end,
a first panel attached to said first plainer segment end,
a second panel attached to said second plainer segment end.

3. The gas sampling apparatus of claim 2 wherein said first panel further comprises:
a first panel oriented at right angles to the plainer segment said first panel exhibiting a plurality of first panel apertures.

4. The gas sampling apparatus of claim 2 wherein said second panel further comprises:
a second panel oriented at right angles to the plainer segment,
said second panel exhibiting a plurality of second panel apertures.

5. The gas sampling apparatus of claims 3 and 4 wherein said first panel apertures and said second panel apertures correspond and are opposite one another.

6. The gas sampling apparatus of claims 3 and 4 where in said first said first panel apertures are three in number and said second panel apertures are three in number.

7. The gas sampling apparatus of claim 1 wherein said first three-way valve further comprises: a first valve flow directing means having a passage said passage having
a first passage end and a second passage end,
a first valve inlet fluidly connected with said first valve flow directing means,
a first valve left outlet fluidly connected with said first valve flow directing means,
a first valve right outlet fluidly connected with said first valve flow directing means.

8. The gas sampling apparatus of claim 1 wherein the first fixed chuck further comprises:
a first fixed chuck annular body with an internally threaded end and an externally threaded end with a central bore between said internally threaded end and said externally threaded end, said central bore further comprising a first central bore section adjacent to said externally threaded end, a second central bore section adjacent to said internally threaded end, said second central bore section is of a diameter larger than said first central bore section whereby a first seat is formed, said first seat further comprising a seat with an air passage aperture extending through said seat into said first central bore section,
a first plunger depressor having a first finger member and a first transverse member said first plunger depressor being disposed within said second central bore section with said first transverse member communicating with said first seat, said first transverse member further comprising a first transverse member that is rectangular in shape,
a first washer disposed within said second central bore section,
said first washer having a central opening of a diameter larger than said first finger member and smaller than said first transverse member whereby said first finger member may be disposed within said central opening allowing said first washer to rest on said first transverse member, said diameter of said central opening being smaller than the length of said first transverse member and said diameter being larger than the width of said first transverse member, whereby fluid may pass through said first washer and past said first transverse member,
a first plunger depressor retaining cap disposed over said second externally threaded annular body end, said first plunger depressor retaining cap having a central bore.

9. The gas sampling apparatus of claim 1 wherein said first sample container further comprises:
a first annular chamber having a first annular chamber end and a second annular chamber end,
a first end cap having a first end cap interior, a first end cap exterior and a first end cap central aperture,
said first end cap demountably attached to said first end,
a first end cap valve assembly disposed through said first end cap central aperture and within said first annular chamber end,
a second end cap, having a second end cap interior, a second end cap exterior and a second end cap central aperture,
said second end cap demountably attached to said second end,
a second end cap valve assembly disposed through said second end cap central aperture and within said second annular chamber end.

10. The gas sampling apparatus of claim 9 wherein said first annular chamber end further comprises a first swaged edge whereby said first end cap valve assembly is retained within said first annular chamber end.

11. The gas sampling apparatus of claim 10 wherein said first swaged edge further exhibits opposing notches whereby said first end cap valve assembly may be inserted within said first annular chamber end

12. The gas sampling apparatus of claim 9 wherein said first annular chamber end further comprises a plurality of dimples whereby said first end cap valve assembly is retained within said first annular chamber end.

13. The gas sampling apparatus of claim 9 wherein said second annular chamber end further comprises a first swaged edge whereby said second end cap valve assembly is retained within said second annular chamber end.

14. The gas sampling apparatus of claim 13 wherein said second swaged edge further exhibits opposing notches

15. The gas sampling apparatus of claim 9 wherein said second annular chamber end further comprises a plurality of dimples whereby said second end cap valve assembly is retained within said second annular chamber end.

16. The gas sampling apparatus of claim 9 wherein said first end cap valve further comprises:
a first end cap valve body having a transverse base
an annular rubber ring disposed over said first end cap valve body,
said annular rubber ring communicating with said transverse base,
a rigid washer disposed over said first end cap valve body communicating with said rubber ring,
said rigid washer further communicating with said first end cap interior,
a compressor nut disposed over said first end cap valve body communicating with said washer, whereby said rubber ring may be compressed,
a retaining nut disposed over said second externally threaded end and communicating with said first end cap exterior, whereby said first end cap is retained in position over said first annular chamber end,
a plunger activated valve.

17. The gas sampling apparatus of claim 9 wherein said second end cap valve further comprises:
a first end cap valve body having a transverse base
an annular rubber ring disposed over said first end cap valve body,
said annular rubber ring communicating with said transverse base,
a rigid washer disposed over said first end cap valve body communicating with said rubber ring,
said rigid washer further communicating with said first end cap interior,
a compressor nut disposed over said first end cap valve body communicating with said washer, whereby said rubber ring may be compressed,
a retaining nut disposed over said second externally threaded end and communicating with said first end cap exterior, whereby said first end cap is retained in position over said first annular chamber end,
a plunger activated valve.

18. The gas sampling apparatus of claim 16 wherein said plunger-activated valve further comprises:
a plunger valve body having a central cavity, said plunger valve body having an externally threaded plunger valve body first end and a plunger valve body second end, said plunger valve body first end having a first end central bore, said second plunger valve body having a second end central bore,
a plunger disposed through said central cavity, said plunger having a first plunger end and
a second plunger end, said first plunger end disposed through and slidably communicating with said first plunger valve body end central bore, said second plunger end disposed through and slidably communicating with said second plunger valve body end central bore,
a plunger gasket fixed to said second plunger valve body end,
said plunger gasket disposed between said second plunger valve body end and said second plunger end lip
said plunger gasket sealingly communicating with said second plunger end lip,
a spring disposed over said plunger rod and disposed within said plunger valve body central cavity.

19. The gas sampling apparatus of claim 18 wherein said plunger valve body further comprises:
a conical plunger valve body segment between said first plunger valve body end and said second plunger valve body end,
a plunger valve body gasket mounted to said conical plunger valve body segment said plunger valve body gasket,
a first plunger rod support disposed within plunger valve body central cavity proximal to said first plunger body end, said first plunger rod support having a central bore and a plurality of apertures, said plunger rod disposed within said first support central bore,
a second plunger rod support disposed within plunger valve body central cavity proximal to said second plunger body end, said second plunger rod support having a central bore and a plurality of apertures, said plunger rod disposed within said second support central bore.

20. The gas sampling apparatus of claim 18 wherein said plunger further comprises:
a spring stop fixed to said plunger rod,
said spring stop disposed between said first plunger rod support and said second plunger rod support,
said spring stop communicating with said first plunger rod support.

21. The gas sampling apparatus of claim 1 wherein the first spring loaded chuck further comprises:
a chuck head,
a first bushing mounted to said second panel,
said first bushing being disposed through and fixed within an outer aperture of second panel,
a pipe with a first threaded pipe end and a second threaded pipe end,
said first threaded pipe end being disposed within said first internally threaded chuck head end,
said pipe being of such a diameter as to be slidably disposed within said first bushing,
a spring disposed over said pipe between said first spring loaded chuck and said first bushing.
a flexible connector with an internally threaded end disposed

22. The gas sampling apparatus of claim 21 wherein the chuck head further comprises:
a first spring loaded chuck annular body with an internally threaded end and an externally threaded end with a central bore between said internally threaded end and said externally threaded end, said central bore further comprising a first central bore section adjacent to said externally threaded end, a second central bore section adjacent to said internally threaded end, said second central bore section is of a diameter larger than said first central bore section whereby a first seat is formed,
said first seat further comprising a seat with an air passage aperture extending through said seat into said first central bore section,
a first plunger depressor having a first finger member and a first transverse member said first plunger depressor being disposed within said second central bore section with said first transverse member communicating with said first seat, said first transverse member further comprising a first transverse member that is rectangular in shape,
a first washer disposed within said second central bore section,
said first washer having a central opening of a diameter larger than said first finger member and smaller than said first transverse member whereby said first finger member may be disposed within said central opening allowing said first washer to rest on said first transverse member, said diameter of said central opening being smaller than the length of said first transverse member and said diameter being larger than the width of said first transverse member, whereby fluid may pass through said first washer and past said first transverse member,
a first plunger depressor retaining cap disposed over said second externally threaded annular body end, said first plunger depressor retaining cap having a central bore.

23. The gas sampling apparatus of claim 1 wherein said second three-way valve further comprises:
a second valve flow directing means having a passage said passage having a first passage end and a second passage end,
a second valve inlet fluidly connected with said second valve flow directing means,
a second valve left outlet fluidly connected with said second valve flow directing means,
a second valve right outlet fluidly connected with said second valve flow directing means.

24. The gas sampling apparatus of claim 1 wherein the second fixed chuck further comprises:
a first fixed chuck annular body with an internally threaded end and an externally threaded end with a central bore between said internally threaded end and said externally threaded end, said central bore further comprising a first central bore section adjacent to said externally threaded end, a second central bore section adjacent to said internally threaded end, said second central bore section is of a diameter larger than said first central bore section whereby a first seat is formed,
said first seat further comprising a seat with an air passage aperture extending through said seat into said first central bore section,
a first plunger depressor having a first finger member and a first transverse member said first plunger depressor being disposed within said second central bore section with said first transverse member communicating with said first seat, said first transverse member further comprising a first transverse member that is rectangular in shape,
a first washer disposed within said second central bore section,
said first washer having a central opening of a diameter larger than said first finger member and smaller than said first transverse member whereby said first finger member may be disposed within said central opening allowing said first washer to rest on said first transverse member, said diameter of said central opening being smaller than the length of said first transverse member and said diameter being larger than the width of said first transverse member, whereby fluid may pass through said first washer and past said first transverse member,
a first plunger depressor retaining cap disposed over said second externally threaded annular body end, said first plunger depressor retaining cap having a central bore.

25. The gas sampling apparatus of claim 1 wherein said second sample container further comprises:
a first annular chamber having a first annular chamber end and a second annular chamber end,
a first end cap having a first end cap interior, a first end cap exterior and a first end cap central aperture,
said first end cap demountably attached to said first end,
a first end cap valve assembly disposed through said first end cap central aperture and within said first annular chamber end,
a second end cap, having a second end cap interior, a second end cap exterior and a second end cap central aperture,
said second end cap demountably attached to said second end,
a second end cap valve assembly disposed through said second end cap central aperture and within said second annular chamber end.

26. The gas sampling apparatus of claim 25 wherein said first annular chamber end further comprises a first swaged edge whereby said first end cap valve assembly is retained within said first annular chamber end.

27. The gas sampling apparatus of claim 26 wherein said first swaged edge further exhibits opposing notches whereby said first end cap valve assembly may be inserted within said first annular chamber end

28. The gas sampling apparatus of claim 25 wherein said first annular chamber end further comprises a plurality of dimples whereby said first end cap valve assembly is retained within said first annular chamber end.

29. The gas sampling apparatus of claim 25 wherein said second annular chamber end further comprises a first swaged edge whereby said second end cap valve assembly is retained within said second annular chamber end.

30. The gas sampling apparatus of claim 29 wherein said second swaged edge further exhibits opposing notches.

31. The gas sampling apparatus of claim 25 wherein said second annular chamber end further comprises an plurality of dimples whereby said second end cap valve assembly is retained within said second annular chamber end.

32. The gas sampling apparatus of claim 25 wherein said first end cap valve further comprises:
a first end cap valve body having a transverse base
an annular rubber ring disposed over said first end cap valve body,
said annular rubber ring communicating with said transverse base,
a rigid washer disposed over said first end cap valve body communicating with said rubber ring,
said rigid washer further communicating with said first end cap interior,
a compressor nut disposed over said first end cap valve body communicating with said washer, whereby said rubber ring may be compressed,
a retaining nut disposed over said second externally threaded end and communicating with said first end cap exterior, whereby said first end cap is retained in position over said first annular chamber end.
a plunger activated valve.

33. The gas sampling apparatus of claim 25 wherein said second end cap valve further comprises:
a first end cap valve body having a transverse base
an annular rubber ring disposed over said first end cap valve body,
said annular rubber ring communicating with said transverse base,
a rigid washer disposed over said first end cap valve body communicating with said rubber ring,
said rigid washer further communicating with said first end cap interior,
a compressor nut disposed over said first end cap valve body communicating with said washer, whereby said rubber ring may be compressed,
a retaining nut disposed over said second externally threaded end and communicating with said first end cap exterior, whereby said first end cap is retained in position over said first annular chamber end.
a plunger activated valve.

34. The gas sampling apparatus of claim 32 wherein said plunger-activated valve further comprises:
a plunger valve body having a central cavity, said plunger valve body having an externally threaded plunger valve body first end and a plunger valve body second end, said plunger valve body first end having a first end central bore, said second plunger valve body having a second end central bore,
a plunger disposed through said central cavity, said plunger having a first plunger end, and
a second plunger end, said first plunger end disposed through and slidably communicating with said first plunger valve body end central bore, said second plunger end disposed through and slidably communicating with said second plunger valve body end central bore,
a plunger gasket fixed to said second plunger valve body end,
said plunger gasket disposed between said second plunger valve body end and said second plunger end lip
said plunger gasket sealingly communicating with said second plunger end lip.
a spring disposed over said plunger rod and disposed within said plunger valve body central cavity.

35. The gas sampling apparatus of claim 34 wherein said plunger valve body further comprises:
a conical plunger valve body segment between said first plunger valve body end and said second plunger valve body end,
a plunger valve body gasket mounted to said conical plunger valve body segment said plunger valve body gasket,
a first plunger rod support disposed within plunger valve body central cavity proximal to said first plunger body end, said first plunger rod support having a central bore and a plurality of apertures, said plunger rod disposed within said first support central bore,
a second plunger rod support disposed within plunger valve body central cavity proximal to said second plunger body end, said second plunger rod support having a central bore and a plurality of apertures, said plunger rod disposed within said second support central bore,

36. The gas sampling apparatus of claim 34 wherein said plunger further comprises:
a spring stop fixed to said plunger rod,
said spring stop disposed between said first plunger rod support and said second plunger rod support,
said spring stop communicating with said first plunger rod support.

37. The gas sampling apparatus of claim 1 wherein the second fixed chuck further comprises:
a first fixed chuck annular body with an internally threaded end and an externally threaded end with a central bore between said internally threaded end and said externally threaded end, said central bore further comprising a first central bore section adjacent to said externally threaded end, a second central bore section adjacent to said internally threaded end, said second central bore section is of a diameter larger than said first central bore section whereby a first seat is formed, said first seat further comprising a seat with an air passage aperture extending through said seat into said first central bore section,
a first plunger depressor having a first finger member and a first transverse member said first plunger depressor being disposed within said second central bore section with said first transverse member communicating with said first seat, said first transverse member further comprising a first transverse member that is rectangular in shape,
a first washer disposed within said second central bore section,
said first washer having a central opening of a diameter larger than said first finger member and smaller than said first transverse member whereby said first finger member may be disposed within said central opening allowing said first washer to rest on said first transverse member, said diameter of said central opening being smaller than the length of said first transverse member and said diameter being larger than the width of said first transverse member, whereby fluid may pass through said first washer and past said first transverse member,
a first plunger depressor retaining cap disposed over said second externally threaded annular body end, said first plunger depressor retaining cap having a central bore.

38. The gas sampling apparatus of claim 1 wherein the first spring loaded chuck further comprises:
a chuck head,
a first bushing mounted to said second panel,
said first bushing being disposed through and fixed within an outer aperture of second panel,
a pipe with a first threaded pipe end and a second threaded pipe end,
said first threaded pipe end being disposed within said first internally threaded chuck head end,
said pipe being of such a diameter as to be slidably disposed within said first bushing,
a spring disposed over said pipe between said first spring loaded chuck and said first bushing.
a flexible connector with an internally threaded end disposed

39. The gas sampling apparatus of claim 38 wherein the chuck head further comprises:
a first spring loaded chuck annular body with an internally threaded end and an externally threaded end with a central bore between said internally threaded end and said externally threaded end, said central bore further comprising a first central bore section adjacent to said externally threaded end, a second central bore section adjacent to said internally threaded end, said second central bore section is of a diameter larger than said first central bore section whereby a first seat is formed, said first seat further comprising a seat with an air passage aperture extending through said seat into said first central bore section,
a first plunger depressor having a first finger member and a first transverse member said first plunger depressor being disposed within said second central bore section with said first transverse member communicating with said first seat, said first transverse member further comprising a first transverse member that is rectangular in shape,
a first washer disposed within said second central bore section,
said first washer having a central opening of a diameter larger than said first finger member and smaller than said first transverse member whereby said first finger member may be disposed within said central opening allowing said first washer to rest on said first transverse member, said diameter of said central opening being smaller than the length of said first transverse member and said diameter being larger than the width of said first transverse member, whereby fluid may pass through said first washer and past said first transverse member,
a first plunger depressor retaining cap disposed over said second externally threaded annular body end, said first plunger depressor retaining cap having a central bore.

40. The sample extraction assembly of claim 1 further comprising:
a coupler,
a sample release device.

41. The sample extraction assembly of claim 40 wherein the coupler further comprises:
a body having a central longitudinal bore an externally threaded first body end and an internally threaded second body end with said central longitudinal bore therebetween,
an annular bushing having and annular bushing central bore,
said annular bushing disposed within and communicating with said second larger diameter segment,
an internally threaded bushing retaining cap having a central bore,
said internally threaded busing retaining cap disposed over externally threaded first body end,
a first seal disposed within said bushing retaining cap.
a second seal within said central longitudinal bore,
a third seal within said central longitudinal bore

42. The sample extraction assembly of claim 41 wherein the body further comprises:
a small diameter segment exhibiting said central longitudinal bore,
a first larger diameter segment exhibiting said central longitudinal bore between said small diameter segment and said internally threaded second body end, whereby a first lip is formed,
a first largest diameter segment exhibiting said central longitudinal bore between said first larger diameter segment and internally threaded second body end,
whereby a second lip is formed,
a second larger diameter segment exhibiting said central longitudinal bore between said small diameter segment and said externally threaded first body end,
whereby a third lip is formed.

43. The gas sampling tube of claim 42 where in said first seal communicates with said third lip, said second seal communicates with said second lip and said third seal communicates with said third lip.

44. The sample extraction assembly of claim 40 wherein the sample release device further comprises:
a septum,
a septum seat,
a stem having a central longitudinal bore,
said stem having a first stem end and an internally threaded second stem end stem,
said first stem being communicating with said externally threaded septum seat,
an internally threaded septum retaining cap having a central conical aperture,
said septum retaining cap disposed over externally threaded septum seat with said septum therebetween,
a spring disposed over said stem between said septum seat and said bushing retaining cap.

45. The gas sampling apparatus of claim 44 wherein said stem further comprises:
a stem wherein said stem obtains a diameter whereby said stem may slidably communicate with said small diameter median central longitudinal bore and slidably communicate with said annular bushing interior and said bushing cap central bore.

46. The gas sampling apparatus of claim 44 wherein said septum is of substantially the same diameter as said externally threaded septum seat and sealingly communicating therewith, whereby said stem central longitudinal bore is occluded.

47. The gas sampling apparatus of claim 44 wherein the internally threaded second stem end further comprises:
an externally threaded stem retaining screw having a threaded portion and a cap portion.

48. The gas sampling apparatus of claim 47 wherein said stem retaining screw cap is of a diameter larger than said stem and whereby said cap thereby rests on said second lip and whereby said stem is retained within said coupler.

49. The gas sampling apparatus of claim 1 wherein said extension rod pressurizer further comprises:
an internally threaded tube capable of being disposed over said first end cap valve assembly,
a bolt having external threads disposed within said internally threaded tube,
a lock nut,
being disposed over said bolt and communicating with said threaded tube,
whereby the position of said bolt within said internally threaded tube is maintained and when loosed the length of said extension rod pressurizer may be increased.

50. The gas sampling apparatus of claim 1 wherein said first sample container is cylindrical in shape with and internally threaded first end and an internally threaded second end with externally threaded first and second end cap valves.

51. The gas sampling apparatus of claim 1 wherein said first three-way valve and said second three-way valve exhibit pressure gauges on said valve inlet and valve outlet whereby pressure may be monitored.

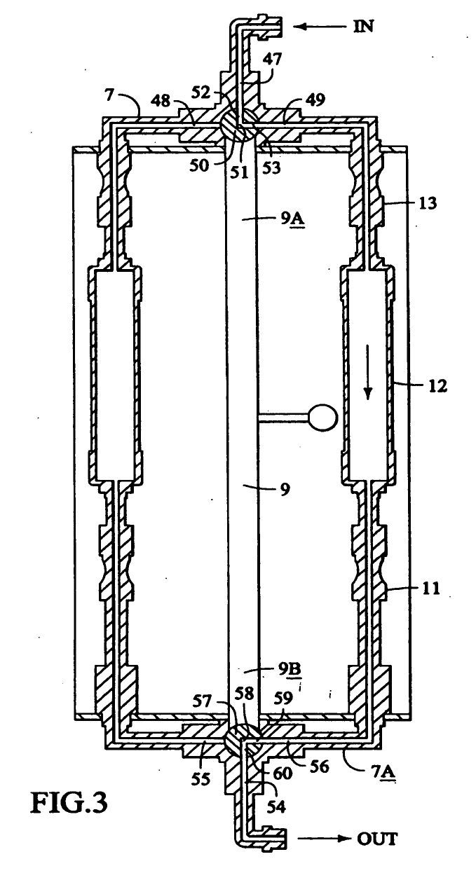

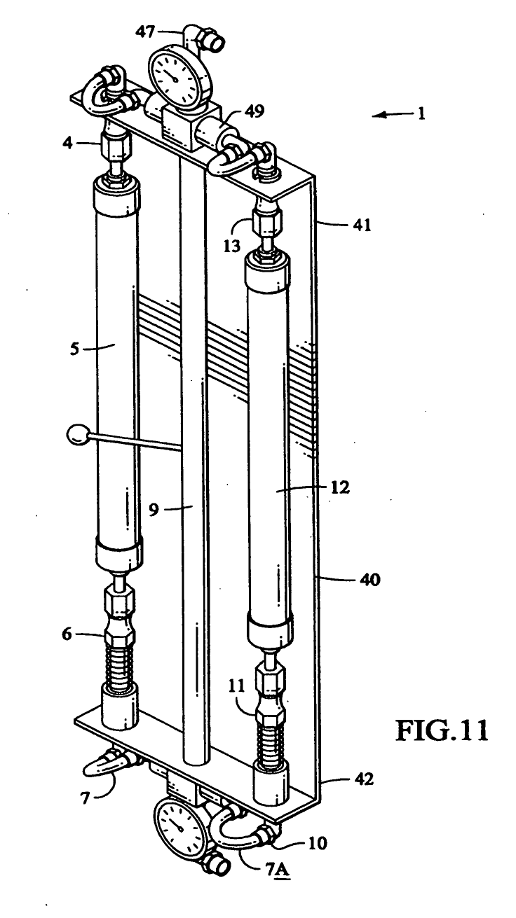

52. The apparatus as shown and described in specification and description in FIGS. 1-16.
